(19) United States
(12) Patent Application Publication
(10) Pub. No.: US 2005/0010424 A1
(43) Pub. Date: Jan. 13, 2005

(54) Method of optimizing pick-to-ship process

(76) Inventors: Marc Alan Sherman, Fort Worth, TX (US); Jeffrey Ronell Smith, Edmund, OK (US)

Correspondence Address: David W. Carstens, P.O. Box 802334, Dallas, TX, 75380, US

(21) Appl. No.: 10/614,761

(22) Filed: Jul. 8, 2003

(51) Int. Cl. G06F 17/60

(52) U.S. Cl. 705/1; 705/28

(57) ABSTRACT

A method, program and system for fulfilling orders is provided by the present invention. The invention includes receiving a product order that specifies product type and quantity and then printing a document that lists the content of the order. An order identification code (i.e. barcode) on the document is input by warehouse personnel. Next a product identification code taken from a physical product is input and compared with the product order. If the product corresponding to the product identification code is part of the order, acquisition of the product is confirmed and it is toward completion of the order. If the product corresponding to the product identification code is not part the order, an error signal is returned. The above steps are repeated until the specified quantity of each product type in the order is entered. An error signal is returned if more than the specified quantity of any product in the order is input. The order is completed and a shipping label is printed only after all products contained in the order have been acquired and entered in the specified quantity.

### BACKGROUND OF THE INVENTION

1. Technical Field

The present invention relates to fulfillment of custom orders.

2. Description of Related Art

The process of filling product orders typically occurs in two stages, one for assembling the order itself and another for packing and shipping the order. Many product orders are filled with the use of a “pick” document, which serves as a checklist that warehouse personnel use in gathering items to be included in an order. Typically, picking documents are printed, the product is picked from storage bins and placed into a shipping box, which is then placed on a conveyor belt that carries it to a shipping station. At the shipping station a shipping document, Mobile Identification Number (MIN) label and shipping label are printed, and the order is shipped. Once the paperwork prints it is placed in the box and sent to the carrier (e.g. FedEx or UPS). In this process, the product is being handled twice at two separate stations, once for picking, once for shipping.

This two-stage process of fulfilling a product order naturally requires both greater labor and more time compared to a single-stage fulfillment process. Therefore, it would be desirable to have a method for combining into a single process the stage of picking items for an order with the stage of preparing the order for shipment.

### SUMMARY OF THE INVENTION

The present invention provides a method, program and system for fulfilling orders. The invention includes receiving a product order that specifies product type and quantity and then printing a document that lists the content of the order. An order identification code (i.e. barcode) on the document is input by warehouse personnel. Next a product identification code taken from a physical product is input and compared with the product order. If the product corresponding to the product identification code is part of the order, acquisition of the product is confirmed and it is toward completion of the order. If the product corresponding to the product identification code is not part the order, an error signal is returned. The above steps are repeated until the specified quantity of each product type in the order is entered. An error signal is returned if more than the specified quantity of any product in the order is input. The order is completed and a shipping label is printed only after all products contained in the order have been acquired and entered in the specified quantity.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 depicts a flowchart illustrating an order fulfillment process in accordance with the present invention;

FIG. 5 depicts a flowchart illustrating the process of selecting the best carrier for an order shipment in accordance with the present invention; and

FIG. 6 depicts a flowchart illustrating quality control checking for orders in accordance with the present invention.

### DETAILED DESCRIPTION OF THE INVENTION

Unlike previous methods for fulfilling product orders, the present invention streamlines the process into a single stage. The new process uses a reconfigured picking document that includes all information required on the shipping document and has a peel off label on which a Mobile Identification Number (MIN) is printed. This document is used to both pick document and shipping document. The method of the present invention allows one person to do the work of two people in the old system.

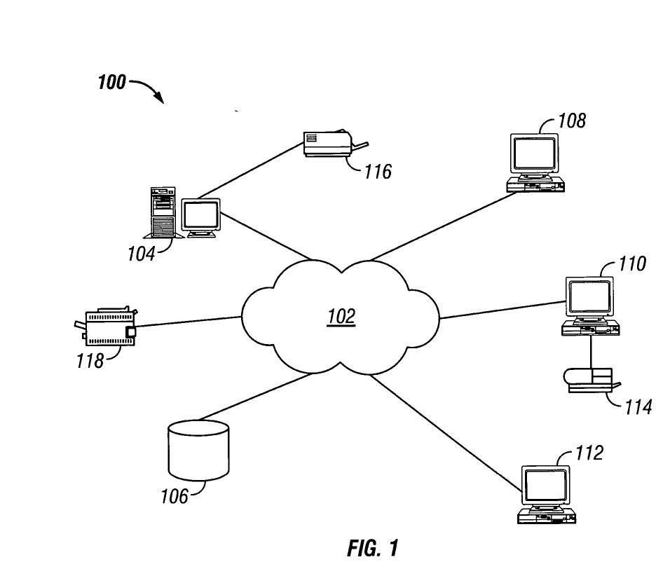

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 includes printers 114, 116, and 118, and may also include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

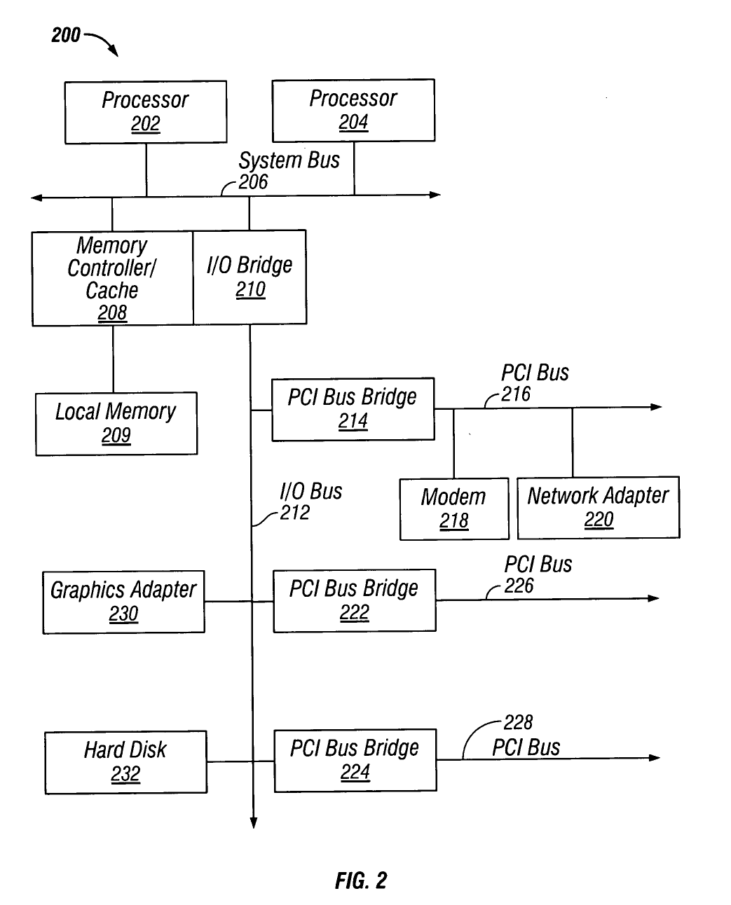

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an eServer pSeries system, a product of International Business Machines Corporation in Armonk, N.Y., running the Advanced Interactive Executive (AIX) or Linux operating systems.

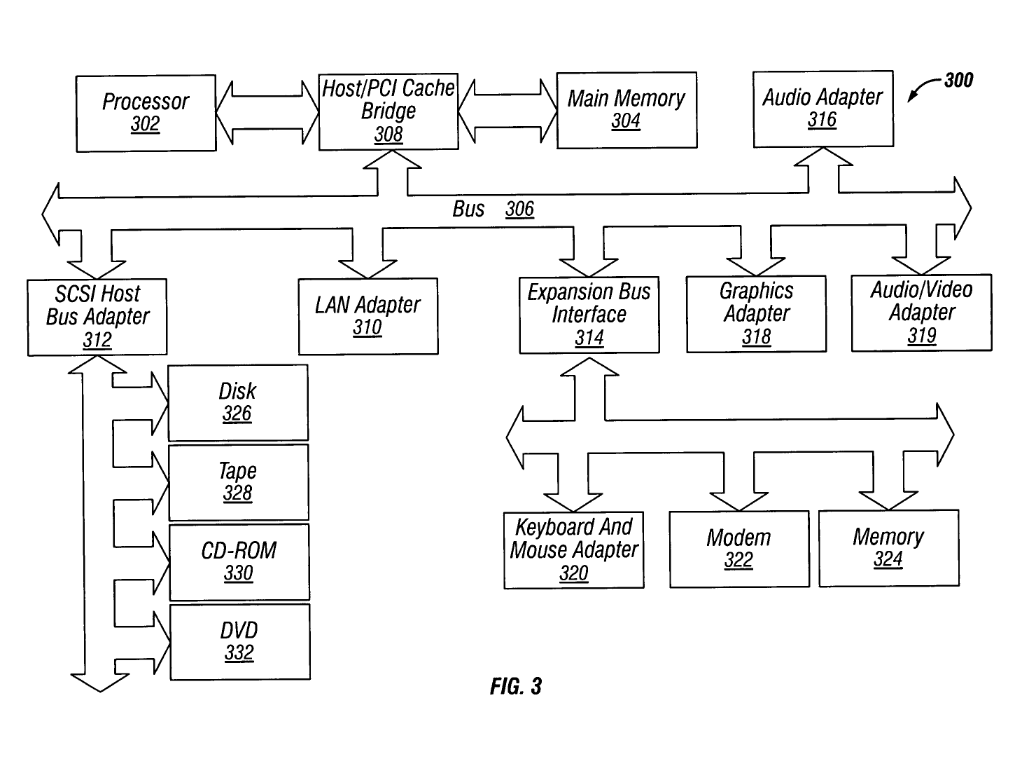

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

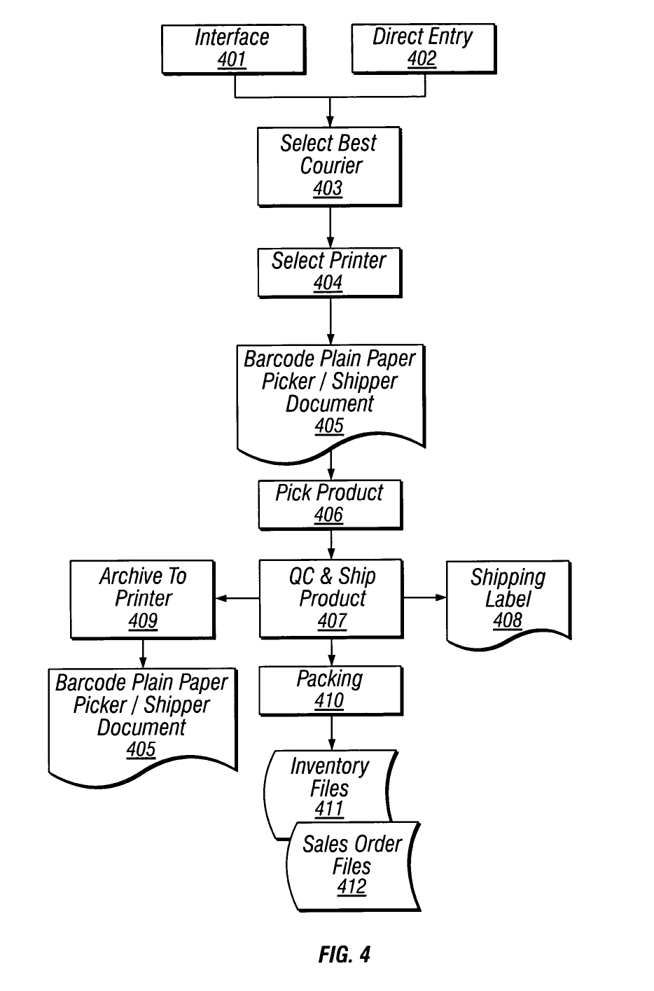

Referring now to FIG. 4, a flowchart illustrating an order fulfillment process is depicted in accordance with the present invention. This process is also referred to as pick-to-ship, which includes picking correct items from warehouse storage locations and assembly an order for shipment. The process begins by an input of an order through either an interface (step 401) or through direct entry (step 402). An order coming through an interface is placed into a separate order management system that may or may not be operated by the distribution center (usually not) and is interfaced to InfoFlo-utilizing middleware or a File Transport Protocol (FTP) process. A directly entered ordered is placed using the same application, in the present example InfoFlo, using a client session. Based on the details of the order, the system selects the best courier for delivery (step 403). Examples of criteria that might be used to determine the best courier include the customer's delivery time preference, shipping location, and the size of the order.

The system then selects the correct printer on which to print a picking document 405 for warehouse personnel (step 404). Selecting the correct printer allows the picking document 405 to be printed at the warehouse location where the items included in the order are stored. The process begins by first determining, based on Part Number, where the requested inventory is located. Next, based on which printers have been assigned to that area, the system selects the printer to which the pick document 405 is routed and printed.

The picking document 405 includes a barcode (or other identifier) for the order number and all detail lines associated with that order which is used by warehouse personnel to pick the correct products from warehouse storage bins (step 406). In addition to the items and quantities included in the order, the picking document 405 also contains all of the shipping information for the order and thus doubles as a shipping document. The person filling the order uses this pick-to-ship document 405 to pick the items requested in the order and place them into a shipping box and then uses the same document 405 to ship the order at his/her picking station. A Mobile Identification Number (MIN) label is peeled off the picking document 405 and attached to the equipment that is now tied to the order.

After the items are retrieved from their respective bins and assembled for fulfilling the order, the system performs a quality control check (explained below) and creates the shipping order (step 407). A shipping label 408 is printed for the shipping box containing the order and the order is also archived by printing a complete document which includes all data from the order including the serial number of the item's shipped that are now tied to the MIN number of the customer to maintain a record of the fulfilled order (step 409). The archived order may be used to print another copy of the original barcoded picking document 405 for future reference.

After the order is checked for accuracy and the shipping label 408 is created, the order is packed and sent off for shipping, with the picking document 405 included as the packing slip (step 410). In one embodiment of the present invention, another layer of quality control can be added to the packing and shipping step, which consists of weighing the package just before it is sealed and sent. The weight of each type of item in the inventory is entered into the system. Using this data, the system can determine what the outgoing package should weight according to the items and quantities included in the order. If there is a discrepancy between what the package should weigh and what it does weigh, the package is diverted to personnel for correction and manual checking.

After packing and shipping, inventory files 411 and sales order files 412 are also updated to include the newly fulfilled order.

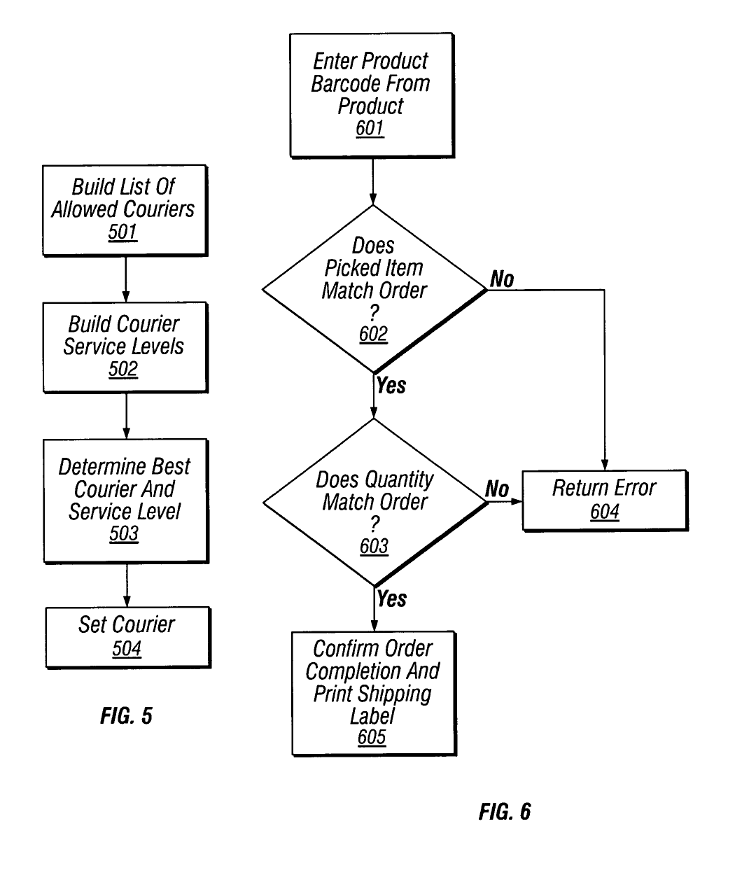

Referring to FIG. 5, a flowchart illustrating the process of selecting the best carrier for an order shipment based on predefined roles is depicted in accordance with the present invention.

FIG. 5 details step 403 in FIG. 4. The process begins by building a list of allowed carriers (step 501). These may be chosen and supplied by the customer and set up in a control record. Selection may be based on the warehouse from which the product is being shipped, which indicates the type of order, e.g. direct fulfillment or warranty exchange. Exceptions can be made as requested, e.g. ensuring that orders being placed by FedEx are shipped via FedEx and not UPS. From the list of allowed carriers, the system builds courier service levels (step 502).

These levels are determined by factors such as speed of delivery, geographic area covered, freight capacity and cost.

When an order is received, the carrier and service level information are compared against a control record that determines if an order is allowed to use that predefined information (step 503). Factors used in this determination might include the expressed customer preference based on sales channel, the shipping destination, and the size of the order. Based on this determination, the system then sets the courier and service level for the order (step 504).

Referring to FIG. 6, a flowchart illustrating quality control checking for orders is depicted in accordance with the present invention. FIG. 6 details the process in step 407 in FIG. 4. Warehouse personnel filling an order scan a barcode (or other identifier) on each item as that item is picked from its respective storage bin (step 601). The system compares the barcodes from the physical items to the detail lines associated with the picking document and makes sure they are the same (step 602). If there is a discrepancy between the ordered item on the picking sheet and the item actually picked by the person filling the order, the system returns an error message and will not allow the order to be completed until the mistake is corrected (step 604).

The system then determines if the number of items picked and scanned matches the quantity specified in the order (step 603). If the number is incorrect, the system again returns an error message (step 604). There are two ways in which a quantity error can be generated. The first way is to scan too many items. The second way is attempting to complete the order and print a shipping label before scanning all of the items specified on the picking document.

Once the system has determined that all of the correct items in the order have been scanned and matched with the picking document details, the system will confirm the completion of the order and print the shipping label (step 605).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for fulfilling orders, the method comprising the computer implemented steps of:
(a) receiving a product order, wherein the order specifies product type and quantity;
(b) printing a document that lists the content of the order and includes an order identification code;
(c) receiving an input of the order identification code,
(d) receiving an input of a product identification code taken from a physical product;
(e) comparing the product identification code with the product order;
(f) if the product corresponding to the product identification code is part of the order, confirming acquisition of the product and entering it toward completion of the order;
(g) if the product corresponding to the product identification code is not part the order, returning an error signal;
(h) repeating steps (d) through (g) until the specified quantity of each product type in the order is entered, and returning an error signal if more than the specified quantity of any product in the order is input; and
(i) completing the order and printing a shipping label for the order only after all products contained in the order have been acquired and entered in the specified quantity.

2. The method according to claim 1, wherein the document includes a label containing a mobile identification number than can be peeled off and placed on the outside of a box containing the ordered items.

3. The method according to claim 1, wherein the document includes a shipping address for the order and serves as a packing list.

4. The method according to claim 1, wherein the identification codes are barcodes that are entered by scanning.

5. A computer program product in a computer readable medium, for fulfilling orders, the computer program product comprising:
(a) first instructions for receiving a product order, wherein the order specifies product type and quantity;
(b) second instructions for printing a document that lists the content of the order and includes an order identification code;
(c) third instructions for receiving an input of the order identification code,
(d) fourth instructions for receiving an input of a product identification code taken from a physical product;
(e) fifth instructions for comparing the product identification code with the product order;
(f) sixth instructions for confirming acquisition of the product and entering it toward completion of the order if the product corresponding to the product identification code is part of the order;
(g) seventh instructions for returning an error signal if the product corresponding to the product identification code is not part the order;
(h) eighth instructions for repeating steps (d) through (g) until the specified quantity of each product type in the order is entered, and returning an error signal if more than the specified quantity of any product in the order is input; and
(i) ninth instructions for completing the order and printing a shipping label for the order only after all products contained in the order have been acquired and entered in the specified quantity.

6. The computer program product according to claim 4, wherein the second instructions for printing the document include instructions for printing a label containing a mobile identification number than can be peeled off and placed on the outside of a box containing the ordered items.

7. The computer program product according to claim 4, wherein the second instructions for printing the document include instructions for printing a shipping address for the order, wherein the document serves as a packing list.

8. The computer program product according to claim 4, wherein the identification codes are barcodes.

9. A system for fulfilling orders, comprising:
(a) a communication mechanism for receiving a product order, wherein the order specifies product type and quantity;
(b) a first printer for printing a document that lists the content of the order and includes an order identification code;
(c) a first input component for receiving an input of the order identification code,
(d) a second input component for receiving an input of a product identification code taken from a physical product;
(e) a comparator for comparing the product identification code with the product order;
(f) an item entry component for confirming acquisition of the product and entering it toward completion of the order if the product corresponding to the product identification code is part of the order;
(g) an error component for returning an error signal if the product corresponding to the product identification code is not part the order;
(h) a component for repeating steps (d) through (g) until the specified quantity of each product type in the order is entered, and returning an error signal if more than the specified quantity of any product in the order is input; and
(i) a second printer for printing a shipping label for the order only after all products contained in the order have been acquired and entered in the specified quantity and the order is completed.

10. The system according to claim 9, wherein the document includes a label containing a mobile identification number than can be peeled off and placed on the outside of a box containing the ordered items.

11. The system according to claim 9, wherein the document includes a shipping address for the order and serves as a packing list.

12. The system according to claim 9, wherein the identification codes are barcodes that are entered by scan.
